(19) United States
(12) Patent Application Publication
(10) Pub. No.: US 2012/0065939 A1
(43) Pub. Date: Mar. 15, 2012

(54) NETWORKED MOTOR, REMOTE DATA ACQUISITION THEREFOR, AND FAULT DIAGNOSIS SYSTEM THEREFOR

(75) Inventor: Yong ZHAO, Zhongshan (CN)

(73) Assignee: Zhongshan Broad-Ocean Motor Manufacturing Co., Ltd., Zhongshan (CN)

(21) Appl. No.: 13/224,313

(22) Filed: Sep. 1, 2011

Related U.S. Application Data
(63) Continuation of application No. PCT/CN2010/070401, filed on Jan. 28, 2010.

(30) Foreign Application Priority Data
Jun. 21, 2009 (CN) 200910040556.2

(51) Int. Cl. G06F 15/00

(52) U.S. Cl. 702/188

(57) ABSTRACT

A networked motor, including a motor body, including a stator, a rotor, and a housing, and a motor controller, including a power circuit, a digital controller, a drive module, and a detecting circuit. A communication circuit module is connected to the digital controller. The communication circuit module includes a wired communication module or a wireless communication module. The wired communication module or the wireless communication module is disposed in or outside the motor controller.

### CROSS-REFERENCE TO RELATED APPLICATIONS

This application is a continuation of International Patent Application No. PCT/CN2010/070401 with an international filing date of Jan. 28, 2010, designating the United States, now pending, and further claims priority benefits to Chinese Patent Application No. 200910040556.2 filed on Jun. 21, 2009. The contents of all of the aforementioned applications, including any intervening amendments thereto, are incorporated herein by reference.

### BACKGROUND OF THE INVENTION

1. Field of the Invention

The invention relates to a networked motor, and a remote data acquisition therefor and fault diagnosis system therefor.

2. Description of the Related Art

Nowadays, some motors communicate in a manner of short messages via wireless mobile networks, and background computers analyze data, and diagnose and handle faults of the motors in time. However, remote data acquisition and fault diagnosis systems for the motors have the following problems: 1) only wireless communication, and no wired communication can be used, which makes it difficult to facilitate in areas with no wireless signal coverage; 2) communication is facilitated in a manner of short messages, data flow is small, and makes it inconvenient to quickly handle faults; 3) communication thereof is single, and it is impossible to select appropriate communication according to practical installation environments; and 4) a technical scheme thereof is unreasonable, which increases application cost.

### SUMMARY OF THE INVENTION

In view of the above-described problem, it is an objective of the invention to provide a networked motor that is capable of addressing above-mentioned problems.

It is another objective of the invention to provide a remote data acquisition and fault diagnosis system for a networked motor that is capable of addressing above-mentioned problems.

To achieve the above objectives, in accordance with one embodiment of the invention, provided is a networked motor, comprising a motor body, comprising a stator, a rotor, and a housing, and a motor controller, comprising a power circuit, a digital controller, a drive module, and a detecting circuit, a communication circuit module is connected to the digital controller, the communication circuit module comprises a wired communication module or a wireless communication module, and the wired communication module or the wireless communication module is disposed in or outside the motor controller.

In a class of this embodiment, the wireless communication module is a GSM module, or a CDMA module, and the wired communication module is the Internet-based or LAN-based Ethernet module.

In a class of this embodiment, the motor controller is connected to the GSM module, the CDMA module, or the Ethernet module via a serial port.

In a class of this embodiment, the digital controller is a micro controller unit, or a digital signal processor.

In accordance with another embodiment of the invention, provided is a remote data acquisition and fault diagnosis system for a networked motor, comprising a network motor, comprising a motor body, comprising a stator, a rotor, and a housing, and a motor controller, comprising a power circuit, a digital controller, a drive module, and a detecting circuit, a communication network, and a background computer, a communication circuit module is connected to the digital controller, the communication circuit module comprises a wired communication module or a wireless communication module, the wired communication module or the wireless communication module is disposed in or outside the motor controller, the networked motor is connected to the communication network via the wired communication module, or the wireless communication module, the networked motor has a unique identification address, the communication network can be a wired network, or a network composed of a wireless network and a wired network, the background computer is accessed to the wired network, the background computer has a unique identification address, and the digital controller in the networked motor is connected to the background computer via the wired network, or to the background computer via the wireless network, and the wired network.

In a class of this embodiment, the wireless network is a GSM network, or a CDMA network, and the wired network is the Internet, or a LAN.

In a class of this embodiment, a monitoring software module is disposed in the digital controller of the networked motor, and operates to perform self-test on the motor and a controller thereof during shutdown thereof, to monitor operation status and intermediate process parameters during operation thereof, to sort, count, warn and intervene in faults, and to communication with the background computer, and a fault acquisition and diagnosis application package is installed on the background computer, and operates to communicate with monitoring software of different motors, to determine and handle types of faults, to record and analyze the faults, to on-line monitor particular objects, and to operate as a man-machine interface.

In a class of this embodiment, the digital controller is a micro controller unit, or a digital signal processor.

In a class of this embodiment, the communication network communicates via the TCP/IP protocol, or via the GSM short message protocol.

Advantages of the invention comprise: 1) the networked motor of the invention has wired communication and wireless communication functions, and is capable of flexibly selecting therefrom, which features convenient use, and using different communication networks, a technical scheme thereof is simple and mature, and easy for implementation, and the invention features simple structure; 2) for the remote data acquisition and fault diagnosis system for the networked motor, the digital controller of the motor transfers data of the motor to the background computer for processing via the communication circuit module, and the communication network, and flexibly selects the wired network or the wireless network for communication according to practical environments, which makes use convenient, and features large data flow of communication, fast and convenient handling, various communication, and high flexibility.

### BRIEF DESCRIPTION OF THE DRAWINGS

FIG. 1 illustrates operation principle of the invention; and

FIG. 2 is a detailed schematic view of FIG. 1.

### DETAILED DESCRIPTION OF THE EMBODIMENTS

Further description of the invention will be given below in conjunction with specific embodiments and accompanying drawings.

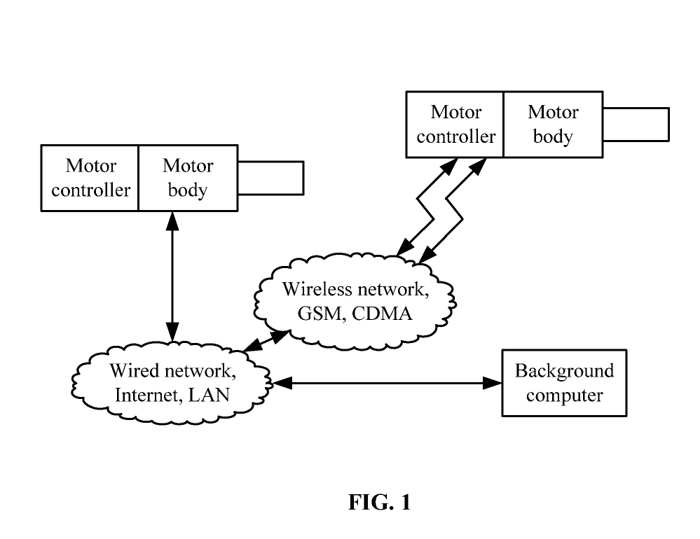

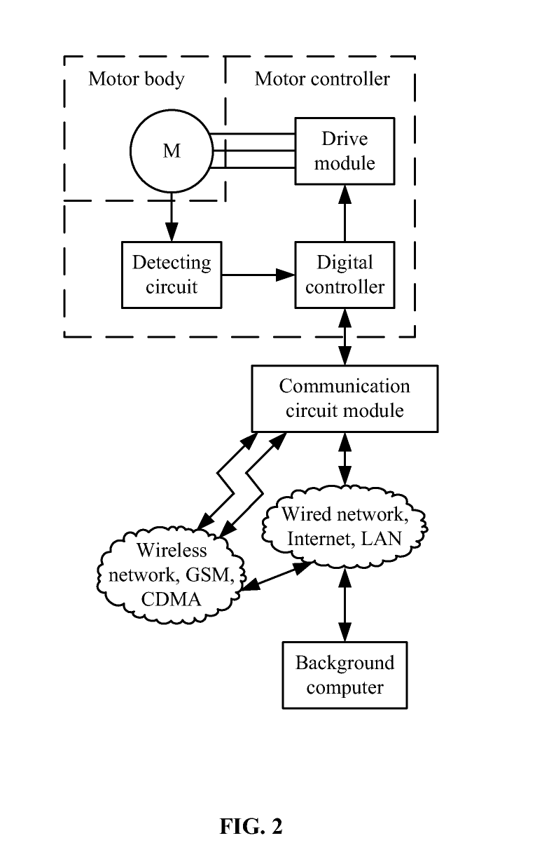

As shown in FIGS. 1 and 2, a networked motor of the invention comprises a motor body, and a motor controller. The motor body comprises a stator, a rotor, and a housing. The motor controller comprises a power circuit, a digital controller, a drive module, and a detecting circuit.

A communication circuit module is connected to the digital controller, the communication circuit module comprises a wired communication module or a wireless communication module, and the wired communication module or the wireless communication module is disposed in or outside the motor controller.

The wireless communication module is a GSM module, or a CDMA module, and the wired communication module is the Internet-based or LAN-based Ethernet module.

The motor controller is connected to the GSM module, the CDMA module, or the Ethernet module via a serial port.

The digital controller is a micro controller unit, or a digital signal processor.

Operation principle of the networked motor is: the detecting circuit detects operation parameters of the motor, and transmits them to the digital controller, then the digital controller outputs a control signal to the drive module via the operation parameters, and the drive module drives the motor body to operate in an expected manner. Moreover, the digital controller may transmit the operation parameters to the background computer for analyzing and handling via the communication circuit module, and the communication network.

A remote data acquisition and fault diagnosis system for a networked motor of the invention comprises a networked motor, a communication network, and a background computer. The networked motor comprises a motor body, and a motor controller. The motor body comprises a stator, a rotor, and a housing. The motor controller comprises a power circuit, a digital controller, a drive module, and a detecting circuit.

A communication circuit module is connected to the digital controller, the communication circuit module comprises a wired communication module or a wireless communication module, the wired communication module or the wireless communication module is disposed in or outside the motor controller, the networked motor is connected to the communication network via the wired communication module, or the wireless communication module, the networked motor has a unique identification address, for example, an IP address, the communication network can be a wired network, or a network composed of a wireless network and a wired network, the background computer is accessed to the wired network, the background computer has a unique identification address, for example, an IP address, and the digital controller in the networked motor is connected to the background computer via the wired network, or to the background computer via the wireless network, and the wired network.

The wireless network is a GSM network, or a CDMA network, and the wired network is the Internet, or a LAN.

A monitoring software module is disposed in the digital controller of the networked motor, and operates to perform self-test on the motor and a controller thereof during shutdown thereof, to monitor operation status and intermediate process parameters during operation thereof, to sort, count, warn and intervene in faults, and to communication with the background computer.

A fault acquisition and diagnosis application package is installed on the background computer, and operates to communicate with monitoring software of different motors, to determine and handle types of faults, to record and analyze the faults, to on-line monitor particular objects, and to operate as a man-machine interface.

The digital controller is a micro controller unit, or a digital signal processor.

The communication network communicates via the TCP/IP protocol, or via the GSM short message protocol.

Operation of the remote data acquisition and fault diagnosis system for the networked motor is: it comprises the networked motor, the communication network, and the background computer. Monitoring software installed in the digital controller of the networked motor operates to perform self-test on the motor and the controller thereof during shutdown thereof, to monitor operation status and the intermediate process parameters during operation thereof, to sort, count, warn and intervene in faults, and to communication with the background computer. The fault acquisition and diagnosis application package installed in the background computer is application-oriented computer application system software package, and operates to communicate with monitoring software of different motors, to determine and handle types of faults, to record and analyze said faults, to collect, analyze and record the faults, and to on-line monitor particular objects. The communication network is a GSM network, or a CDMA network. The wired network is the Internet, or the LAN.

A network card can be disposed in the networked motor, so that the networked motor is connected to the Internet via the Ethernet module, and the background computer can be accessed to the Internet, so that a communication link is established between the networked motor and the background computer.

Alternatively, the networked motor can communicate with the GSM network or the CDMA network via the GSM module, or the CDMA module, and the GSM or CDMA network operators have connected the GSM network and the CDMA network to the Internet. Therefore, the background computer can be connected to the Internet, and a communication link is established between the networked motor and the background computer via the GSM network, the CDMA network, and the Internet.

The above-mentioned communication methods are simple and easy to be facilitated, and feature high reliability.

The fault acquisition and diagnosis application package diagnoses faults of the motor and remove the faults in time, structure thereof is simple, a technology thereof is mature, and application thereof is flexible.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A networked motor, comprising
a motor body, comprising a stator, a rotor, and a housing, and
a motor controller, comprising a power circuit, a digital controller, a drive module, and a detecting circuit,
wherein
a communication circuit module is connected to said digital controller;
said communication circuit module comprises a wired communication module or a wireless communication module; and
said wired communication module or said wireless communication module is disposed in or outside said motor controller.

2. The networked motor of claim 1, wherein
said wireless communication module is a GSM module, or a CDMA module; and
said wired communication module is the Internet-based or LAN-based Ethernet module.

3. The networked motor of claim 2, wherein said motor controller is connected to said GSM module, said CDMA module, or said Ethernet module via a serial port.

4. The networked motor of claim 3, wherein said digital controller is a micro controller unit, or a digital signal processor.

5. A remote data acquisition and fault diagnosis system for a networked motor, comprising
a networked motor, comprising
a motor body, comprising a stator, a rotor, and a housing; and
a motor controller; comprising a power circuit, a digital controller, a drive module, and a detecting circuit;
a communication network; and
a background computer;
wherein
a communication circuit module is connected to said digital controller;
said communication circuit module comprises a wired communication module or a wireless communication module;
said wired communication module or said wireless communication module is disposed in or outside said motor controller;
said networked motor is connected to said communication network via said wired communication module, or said wireless communication module;
said networked motor has a unique identification address;
said communication network can be a wired network, or a network composed of a wireless network and a wired network;
said background computer is accessed to said wired network;
said background computer has a unique identification address; and
said digital controller in said networked motor is connected to said background computer via said wired network, or to said background computer via said wireless network, and said wired network.

6. The remote data acquisition and fault diagnosis system of claim 5, wherein
said wireless network is a GSM network, or a CDMA network; and
said wired network is the Internet, or a LAN.

7. The remote data acquisition and fault diagnosis system of claim 6, wherein
a monitoring software module is disposed in said digital controller of said networked motor, and operates to perform self-test on said motor and a controller thereof during shutdown thereof, to monitor operation status and intermediate process parameters during operation thereof, to sort, count, warn and intervene in faults, and to communication with said background computer; and
a fault acquisition and diagnosis application package is installed on said background computer; and operates to communicate with monitoring software of different motors, to determine and handle types of faults, to record and analyze said faults, to on-line monitor particular objects, and to operate as a man-machine interface.

8. The remote data acquisition and fault diagnosis system of claim 7, wherein said digital controller is a micro controller unit, or a digital signal processor.

9. The remote data acquisition and fault diagnosis system of claim 8, wherein said communication network communicates via the TCP/IP protocol, or via the GSM short message protocol.
